(19) United States
(12) Patent Application Publication
(10) Pub. No.: US 2025/0177926 A1
(43) Pub. Date: Jun. 5, 2025

(54) NICKEL OXIDE (NiO)-DECORATED CERAMIC-ALUMINA POLYMERIC MEMBRANE FOR SEPARATION OF OIL-IN-WATER EMULSIONS

(71) Applicant: KING FAHD UNIVERSITY OF PETROLEUM AND MINERALS, Dhahran (SA)

(72) Inventors: Umair BAIG, Dhahran (SA); Abdul WAHEED, Dhahran (SA); Isam H. ALJUNDI, Dhahran (SA)

(73) Assignee: KING FAHD UNIVERSITY OF PETROLEUM AND MINERALS, Dhahran (SA)

(21) Appl. No.: 18/528,114

(22) Filed: Dec. 4, 2023

(51) Int. Cl. B01D 69/14; B01D 67/00; B01D 69/02; B01D 69/10; B01D 71/56; B01D 71/70; B01D 71/82

(52) U.S. Cl. CPC B01D 69/14111; B01D 67/0006; B01D 69/02; B01D 69/108; B01D 71/56; B01D 71/70; B01D 71/82; B01D 2323/21813; B01D 2323/30; B01D 2323/38; B01D 2323/40; B01D 2325/02833; B01D 2325/02834; B01D 2325/36

(57) ABSTRACT

A membrane including a support and an active layer. The active layer includes reacted units of a polyamine compound, a polyfunctional acid halide compound, and nickel oxide (NiO) nanoparticles (NPs). A surface of the NiO NPs is functionalized with an amino silane compound. The polyamine compound, the polyfunctional acid halide compound, and the amino silane compound are interfacially polymerized on the support to form the membrane.

### STATEMENT OF ACKNOWLEDGEMENT

Support provided by the King Fahd University of Petroleum and Minerals (KFUPM) under grant INMW2213 is gratefully acknowledged.

### BACKGROUND

### Technical Field

The present disclosure is directed to a ceramic-alumina polymeric membrane, particularly a nickel oxide (NiO)-decorated ceramic-alumina polymeric membrane for separating oil-in-water emulsions.

### Description of Related Art

The “background” description provided herein is to present the context of the disclosure generally. Work of the presently named inventors, to the extent it is described in this background section, as well as aspects of the description that may not otherwise qualify as prior art at the time of filing, are neither expressly nor impliedly admitted as prior art against the present invention.

Oil-adulterated wastewater is released from several industries, of which the oil and gas industry is the most common. During oil drilling, three to four barrels of oily wastewater, called produced water, are generated per barrel of oil. The produced water is a highly homogenized oil-in-water (O/W) emulsion containing various components, including inorganic metal ions, organic surfactants, and aromatic compounds. Therefore, oily wastewater, such as produced water, is a useful resource if its components are appropriately separated and reused for numerous applications. For example, if the standards are met, the water recovered from produced water can be used for groundwater recharge and irrigation.

Numerous efforts have been made to clean the produced water or oily wastewater from domestic and industrial setups through different processes at different stages. The various stages of treating wastewater are primary, secondary, and tertiary. Primary treatment is carried out to remove large oil droplets by different processes such as hydrocyclone, API separator, coagulation, and flocculation. Secondary treatment involves adsorption, activated sludge process, and floatation. Further, tertiary treatment is carried out through an advanced oxidation process, electrodialysis, and other relevant techniques such as membrane separation. Membrane separations can be performed at different stages to filter out different sized particles, for example microfiltration (MF) (0.1-10 μm), ultrafiltration (UF) (0.01-0.1 μm), nanofiltration (NF) (0.001-0.01 μm), and reverse osmosis (RO) (<0.001 μm), are some examples of membrane technologies available currently with different pore sizes. Membrane-based separations are useful regarding applicability, energy efficiency, separation potential, ease of operation, and availability in different modules and materials.

Membranes can be made from polymeric and ceramic materials to separate solutes from different feeds. Compared to polymeric membranes, ceramic membranes have potential for treating wastewater because ceramic membranes have high chemical, thermal, and mechanical stabilities, which make ceramic membranes ideal for harsh conditions. However, membranes composed of only ceramic materials such as alumina (Al₂O₃), titania (TiO₂), and silica (SiO₂) can be costly both in terms of material and fabrication cost. Most of the cost of ceramic membranes is due to high-temperature sintering. On the other hand, polymeric membranes offer the freedom of tuning the membrane chemistry and pore size to reject solutes such as emulsified oil from O/W emulsion. Hence, a need arises to develop ceramic-polymeric membranes that exploit the advantageous features of both ceramic and polymeric membranes.

Ceramic microfiltration supports can be coated with a polymeric active layer or inorganic-polymeric composite active layer, yielding an ultrafiltration membrane. The incorporation of inorganic nanoparticles such as iron oxide (Fe₂O₃), zeolites, manganese oxide (MnO₂), copper oxide (CuO), and cerium oxide (CeO₂) has led to membranes with special surface wettability such as superhydrophobicity and underwater superoleophobic nature of the membranes.

The features of membrane surface hydrophilicity and underwater superoleophobicity are required for mitigating membrane surface fouling. An underwater superoleophobic membrane allows water to permeate through the membrane, while oil will not be allowed to pass through the membrane. This happens due to the formation of a dense hydration layer on the membrane surface, which repels the oil and hence blocks the entry of oil into the membrane, which eventually reduces the membrane fouling.

Although several ceramic polymeric membranes have been developed in the past, there still exists a need to develop a cost-effective membrane with improved separation properties. Therefore, it is one object of the present disclosure to provide an affordable oil-water separation membrane that can separate oil-water mixtures with high efficiency and flux rates.

### SUMMARY

In an exemplary embodiment, a ceramic alumina (Al₂O₃) polymeric membrane with nickel oxide (NiO) and a method of separating an oil and water mixture is disclosed. The membrane includes a support and an active layer. The active layer includes reacted units of a polyamine compound, a polyfunctional acid halide compound, and nickel oxide (NiO) nanoparticles (NPs). Further, a surface of the NiO NPs is functionalized with an amino silane compound. Furthermore, the polyamine compound, the polyfunctional acid halide compound, and the amino silane compound are interfacially polymerized on the support to form the membrane.

In some embodiments, the polyamine compound is a cyclic polyamine having 4 to 8 atoms in a ring.

In some embodiments, the polyamine compound has 2 to 5 amine groups.

In some embodiments, the polyfunctional acid halide compound is an aromatic compound with 2 to 5 acyl chloride groups.

In some embodiments, the amino silane compound includes a carbon chain with a terminal primary amine.

In some embodiments, the active layer the NiO NPs are wrapped by polymeric chains formed during interfacial polymerization.

In some embodiments, the NiO NPs are uniformly distributed in the active layer.

In some embodiments, the NiO NPs are covalently bonded in the active layer.

In some embodiments, a first acyl halide group of the polyfunctional acid halide compound is covalently bound to an amine group of the amino silane compound thereby forming an amide bond.

In some embodiments, a second acyl halide group of the polyfunctional acid halide compound is covalently bound to an amine group of the polyamine compound thereby forming an amide bond.

In some embodiments, the support is a ceramic support.

In some embodiments, the support is an alumina support.

In some embodiments, the membrane has an average pore size of less than 1 micrometer (μm).

In some embodiments, the membrane has an average pore size of 1 nanometer (nm) to 100 nm.

In some embodiments, the active layer comprises 1 weight percent (wt. %) to 90 wt. % of the NiO NPs, based on total weight of the active layer.

In some embodiments, the NiO NPs are spherical and have an average diameter of 50 nm to 100 nm.

In some embodiments, the membrane has an oil contact angle in water of greater than 160°.

In another exemplary embodiment, a method of separating an oil and water mixture is disclosed. The method includes passing the oil and water mixture through the aforementioned membrane to form a filtered solution. The filtered solution includes at least 80% less oil in comparison to the oil and water mixture.

In some embodiments, the membrane has a permeate flux of 150 L m⁻² h⁻¹ (LMH) to 250 LMH at 1 bar.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a schematic diagram depicting a preparation of amino-functionalized nickel oxide (NiO) nanoparticles (NPs) (F—NiO) using (3-Aminopropyl)triethoxysilane (APTES) as a functionalizing agent, according to certain embodiments;

FIG. 2 is a schematic diagram depicting fabrication of a F—NiO/PA@Alumina membrane, according to certain embodiments;

FIG. 3 is a schematic diagram depicting interfacial polymerization reaction between F—NiO and isophthaloyl chloride (IPC), yielding the proposed polyamide active layer with NiO particles decorated in the active layer framework, according to certain embodiments;

FIG. 4A depicts powder X-ray diffraction (PXRD) analysis of the NiO, according to certain embodiments;

FIGS. 4B-4C depict scanning electron microscopy (SEM) micrographs of the NiO, at different magnifications, according to certain embodiments;

FIG. 4D depicts energy dispersive X-ray (EDX) analysis of the NiO, according to certain embodiments;

FIG. 4E shows elemental mapping of nickel (Ni) as determined by EDX analysis of the NiO, according to certain embodiments;

FIG. 4F shows elemental mapping of oxygen (O) as determined by the EDX analysis of the NiO, according to certain embodiments;

FIGS. 4G-4H depict SEM micrograph of the F—NiO, at different magnifications, according to certain embodiments;

FIG. 4I depicts the EDX analysis of the F—NiO, according to certain embodiments;

FIG. 4J shows elemental mapping of Ni as determined by EDX analysis of the F—NiO, according to certain embodiments;

FIG. 4K shows elemental mapping of O as determined by the EDX analysis of the F—NiO, according to certain embodiments;

FIG. 4L shows elemental mapping of silicon (Si) as determined by the EDX analysis of the F—NiO, according to certain embodiments;

FIG. 4M shows elemental mapping of carbon (C) as determined by the EDX analysis of the F—NiO, according to certain embodiments;

FIG. 4N shows elemental mapping of nitrogen (N) as determined by the EDX analysis of the F—NiO, according to certain embodiments;

FIG. 5A depicts the Fourier transform Infrared (FTIR) spectra of NiO and F—NiO, according to certain embodiments;

FIG. 5B depicts the respective fingerprint regions of NiO and F—NiO of FIG. 5A, according to certain embodiments;

FIG. 6A depicts FTIR spectra of the alumina support and the F—NiO/PA@Alumina membrane, according to certain embodiments;

FIG. 6B depicts the respective fingerprint regions of the alumina support and the F—NiO/PA@Alumina membrane of FIG. 6A, according to certain embodiments;

FIG. 7 depicts X-ray diffraction (XRD) patterns of the alumina support and the F—NiO/PA@Alumina membrane, according to certain embodiments;

FIG. 8A depicts SEM micrograph of the alumina support at 50 μm magnification, according to certain embodiments;

FIG. 8B depicts SEM micrograph of the alumina support at 10 μm magnification, according to certain embodiments;

FIG. 8C depicts SEM micrograph of the alumina support at 1 μm magnification, according to certain embodiments;

FIG. 8D depicts SEM micrograph of the F—NiO/PA@Alumina membrane at 50 μm magnification, according to certain embodiments;

FIG. 8E depicts SEM micrograph of the F—NiO/PA@Alumina membrane at 10 μm magnification, according to certain embodiments;

FIG. 8F depicts SEM micrograph of the F—NiO/PA@Alumina membrane at 1 μm magnification, according to certain embodiments;

FIG. 9A depicts EDX analysis results of the alumina support, according to certain embodiments;

FIG. 9B depicts the presence of aluminum (Al) in the elemental mapping analysis of the alumina support, according to certain embodiments;

FIG. 9C depicts the presence of O in the elemental mapping analysis of the alumina support, according to certain embodiments;

FIG. 9D depicts the presence of Si in the elemental mapping analysis of the alumina support, according to certain embodiments;

FIG. 9E depicts EDX analysis of the F—NiO/PA@Alumina membrane, according to certain embodiments;

FIG. 9F depicts the presence of C in the elemental mapping analysis of the F—NiO/PA@Alumina membrane, according to certain embodiments;

FIG. 9G depicts the presence of O in the elemental mapping analysis of the F—NiO/PA@Alumina membrane, according to certain embodiments;

FIG. 9H depicts the presence of Ni in the elemental mapping analysis of the F—NiO/PA@Alumina membrane, according to certain embodiments;

FIG. 9I depicts the presence of Si in the elemental mapping analysis of the F—NiO/PA@Alumina membrane, according to certain embodiments;

FIG. 9J depicts the presence of N in the elemental mapping analysis of the F—NiO/PA@Alumina membrane, according to certain embodiments;

FIG. 9K depicts the presence of Al in the elemental mapping analysis of the F—NiO/PA@Alumina membrane, according to certain embodiments;

FIG. 10A depicts the surface wettability analysis of the F—NiO/PA@Alumina membrane through contact angle measurements using both oil and water as wetting media in air as well as in water, according to certain embodiments;

FIG. 10B depicts the effect of transmembrane pressure on the variation of permeate flux of the F—NiO/PA@Alumina membrane, according to certain embodiments;

FIG. 11A depicts the effect of transmembrane pressure on the variation of permeate flux of the F—NiO/PA@Alumina membrane, using 100 ppm crude oil-in-water emulsion, according to certain embodiments;

FIG. 11B depicts the effect of transmembrane pressure on the separation efficiency of the F—NiO/PA@Alumina membrane, using 100 ppm crude oil-in-water emulsion, according to certain embodiments;

FIG. 12A depicts the variation in permeate flux as a function of increasing oil concentration in the oil in water (O/W) emulsion of the F—NiO/PA@Alumina membrane, according to certain embodiments;

FIG. 12B depicts the effect of oil concentration in the O/W emulsion on the separation efficiency of the F—NiO/PA@Alumina membrane, at 2 bar, according to certain embodiments;

FIG. 13A is a light microscopic image of a feed containing 50 ppm of oil in O/W emulsion and a digital image of a permeate resulting after filtering the 50 ppm O/W emulsion through the F—NiO/PA@Alumina membrane, according to certain embodiments;

FIG. 13B is a light microscopic image of a feed containing 100 ppm of oil in O/W emulsion and a digital image of a permeate resulting after filtering the 100 ppm O/W emulsion through the F—NiO/PA@Alumina membrane, according to certain embodiments;

FIG. 13C is a light microscopic image of a feed containing 200 ppm of oil in O/W emulsion and a digital image of a permeate resulting after filtering the 200 ppm O/W emulsion through the F—NiO/PA@Alumina membrane, according to certain embodiments;

FIG. 14A depicts stability testing of the F—NiO/PA@Alumina membrane in terms of variation in the permeate flux, according to certain embodiments;

FIG. 14B depicts separation efficiency of the F—NiO/PA@Alumina membrane using 100 ppm crude oil in the O/W emulsion tested at 2 bar, according to certain embodiments; and

FIG. 15 is a schematic diagram depicting the surfactant stabilized crude oil-in-water emulsion separation using a cross-flow filtration system, according to certain embodiments.

### DETAILED DESCRIPTION

When describing the present disclosure, the terms used are to be construed in accordance with the following definitions, unless a context dictates otherwise.

Embodiments of the present invention will now be described more fully hereinafter with reference to the accompanying drawings wherever applicable, in that some, but not all embodiments of the disclosure are shown.

In the drawings, reference numerals designate identical or corresponding parts throughout the several views. Further, as used herein, the words “a,” “an,” and the like generally carry a meaning of “one or more,” unless stated otherwise.

Where a numerical limit or range is stated herein, the endpoints are included. Also, all values and subranges within a numerical limit or range are specifically included as if explicitly written out.

Furthermore, the terms “approximately,” “approximate,” “about,” and similar terms generally refer to ranges that include the identified value within a margin of 20%, 10%, or preferably 5%, and any values therebetween.

As used herein, the term “nanoparticles (NPs)” refers to particles having a particle size of 1 nanometer (nm) to 500 nm within the scope of the present invention.

As used herein, the term “porosity” refers to a measure of the void or vacant spaces within a material.

As used herein, the terms “particle size” and “pore size” may be thought of as the lengths or longest dimensions of a particle and of a pore opening, respectively.

As used herein, the term “amide bond” refers to R—C(═O)—NR′R″, where R, R′, and R″ represent any group.

As used herein, the term “substituted” refers to at least one hydrogen atom that is replaced with a non-hydrogen group, provided that normal valencies are maintained and that the substitution results in a stable compound. When a substituent is noted as “optionally substituted”, the substituent(s) are selected from alkyl, halo (e.g., chloro, bromo, iodo, fluoro), hydroxyl, alkoxy, oxo, alkanoyl, aryloxy, alkanoyloxy, amino (—NH₂), alkylamino (—NHalkyl), cycloalkylamino (—NHcycloalkyl), arylamino (—NHaryl), arylalkylamino (—NHarylalkyl), disubstituted amino (e.g., in which the two amino substituents are selected from alkyl, aryl or arylalkyl, including substituted variants thereof, with specific mention being made to dimethylamino), alkanoylamino, aroylamino, arylalkanoylamino, thiol, alkylthio, arylthio, arylalkylthio, alkylthiono, arylthiono, arylalkylthiono, alkylsulfonyl, arylsulfonyl, arylalkylsulfonyl, sulfonamide (e.g., —SO₂NH₂), substituted sulfonamide (e.g., —SO₂NHalkyl, —SO₂NHaryl, —SO₂NHarylalkyl, or cases where there are two substituents on one nitrogen selected from alkyl, aryl, or alkylalkyl), nitro, cyano, carboxy, unsubstituted amide (i.e. —CONH₂), substituted amide (e.g., —CONHalkyl, —CONHaryl, —CONHarylalkyl or cases where there are two substituents on one nitrogen selected from alkyl, aryl, or alkylalkyl), alkoxycarbonyl, aryl, guanidine, heterocyclyl (e.g., pyridyl, furyl, morpholinyl, pyrrolidinyl, piperazinyl, indolyl, imidazolyl, thienyl, thiazolyl, pyrrolidyl, pyrimidyl, piperidinyl, homopiperazinyl), and mixtures thereof. The substituents may themselves be optionally substituted, and may be either unprotected, or protected as necessary, as known to those skilled in the art, for example, as taught in Greene, et al., “Protective Groups in Organic Synthesis”, John Wiley and Sons, Second Edition, 1991, hereby incorporated by reference in its entirety.

The term “aromatic compounds” or “aromatic rings”, as used herein, refers to hydrocarbon rings that, by the theory of Hückel, have a cyclic, delocalized (4n+2) pi-electron system. Non-limiting examples of aromatic compounds include benzene, benzene derivatives, compounds having at least one benzene ring in their chemical structure, toluene, ethylbenzene, p-xylene, m-xylene, mesitylene, durene, 2-phenylhexane, biphenyl, phenol, aniline, nitrobenzene, and the like.

As used herein, the term “membrane” refers to a porous structure capable of separating components of a homogeneous or heterogeneous fluid. In particular, “pores” in the sense of the present disclosure indicate voids allowing fluid communication between different sides of the structure. More particular in use when a homogeneous or heterogeneous fluid is passed through the membrane, some components of the fluid can pass through the pores of the membrane into a “permeate stream”, some components of the fluid can be retained by the membrane and can thus accumulate in a “retentate” and/or some components of the fluid can be rejected by the membrane into a “rejection stream”. Membranes can be of various thicknesses, with homogeneous or heterogeneous structures. Membranes can be in the form of flat sheets or bundles of hollow fibers. Membranes can also be in various configurations, including but not limited to spiral wound, tubular, hollow fiber, and other configurations identifiable to a skilled person upon reading the present disclosure. Membranes can also be classified according to their pore diameter. Membranes can be neutral or charged, and particle transport can be active or passive. The latter can be facilitated by pressure, concentration, and chemical or electrical gradients of the membrane process.

As used herein, “contact angle” refers to an angle at which two fluids meet and intersect with a solid surface.

As used herein, “superhydrophilicity” refers to the phenomenon of excess hydrophilicity, or attraction to water; in superhydrophilic materials, the contact angle of water is approximately zero degrees.

As used herein, “superoleophilicity” refers to the phenomenon of excess oleophilicity, or attraction to oil; in superoleophilic materials, the contact angle of oil is approximately zero degrees.

As used herein, “superoleophobicity” refers to the phenomenon where the contact angles of various oil droplets with low surface tension on a solid surface are larger than 150°.

As used herein, “water contact angle” refers to the angle conventionally measured through the liquid, where a liquid-vapor interface meets a solid surface. The water contact angle quantifies the wettability of a solid surface by a liquid via the Young's equation. If the measured contact angle is above 90 degrees, the solid is said to have poor wetting and is termed hydrophobic. If the contact angle is below 90 degrees, the solid is said to have efficient wetting and is termed hydrophilic, e.g., ASTM D5946.

As used herein, “separation efficiency” refers to the ratio of concentration that has been removed from the feed stream to the initial concentration in the feed stream.

As used herein, an “emulsion” refers to a mixture of two or more immiscible liquids.

As used herein, “flux” refers to a metric for comparing, scaling, and assessing the general performance of a membrane. It is defined as the permeate flow per unit of time and membrane surface area, commonly expressed as liters per square meter per hour (L m⁻² h⁻¹).

Aspects of the present disclosure are directed to a ceramic-polymeric membrane, also referred to as a “membrane”. The membrane is fabricated through interfacial polymerization of an amine which thereby covalently incorporates nickel oxide (NiO) nanoparticles in the polyamide active layer on the ceramic support. The fabricated membrane can be used for separating crude oil in an oil-in-water (O/W) emulsion.

A membrane is described. The membrane includes a support and an active layer. The support should possess good mechanical and thermal properties. Also, the support should demonstrate high resistance to chemicals such as aromatic hydrocarbons, ketones, ethers, and esters. The support may include a polymeric support, an inorganic filler, a ceramic support, a composite support, a metal support, an inorganic support, an inorganic support, an inorganic-organic support, and/or a casted support. In some embodiments, polymeric support may include polyacrylonitrile (PAN), polyester such as polyethylene terephthalate (PET), polycarbonate (PC), polyamide (PA), poly(ether) sulfone (PES), polybutylene terephthalate (PBT), polysulfone (PSf), polypropylene (PP), cellulose acetate (CA), poly(piperazine-amide), polyvinylidene difluoride (PVDF), polytetrafluoroethylene (PTFE), chlorinated polyvinyl chloride (CPVC), poly(phthalazinone ether sulfone ketone) (PPESK), polyamide-urea, polyether ether ketone (PEEK), poly(phthalazinone ether ketone), and thin film composite porous film (TFC).

In a preferred embodiment, the support is a ceramic support. A ceramic is a material that is neither metallic nor organic. It may be crystalline, glassy or both crystalline and glassy. Ceramics are typically hard and chemically non-reactive and can be formed or densified with heat. In some embodiments, the support may be silica (SiO₂), alumina (Al₂O₃), barium titanate, sialon (silicon aluminum oxynitride), silicon carbide (SiC), silicon nitride (Si₃N₄), steatite (magnesium silicates), titanium carbide, uranium oxide (UO₂), yttrium barium copper oxide (YBa₂Cu₃O₇₋ₓ), zinc oxide (ZnO), and zirconium dioxide (zirconia). In a most preferred embodiment, the support is an alumina support. In an embodiment, the alumina support comprises alumina particles having an average size of 1-30 μm, preferably 5-25 μm, 10-20 μm, or about 15 μm. In an embodiment, the alumina support is porous and has an average pore size of 0.1-10 μm, preferably 1-9 μm, 2-8 μm, 3-7 μm, or 4-6 μm.

The membrane further includes an active layer. The active layer includes reacted units of a polyamine compound, a polyfunctional acid halide compound, and nickel oxide (NiO) NPs. In some embodiments, the polyamine compound has 2-5 amine groups, preferably 2, preferably 3, preferably 4, and preferably 5 amine groups. Amine group as used herein refers to R—NR′R″, where R, R′, and R″ represent any group. In some embodiments, the polyamine compound is a cyclic polyamine having 4-8 atoms in a ring, preferably 4, preferably 5, preferably 6, preferably 7, and preferably 8 atoms in a ring. In some embodiments, the N of the amine is incorporated as a heteroatom into the ring or substituted on the ring. In some embodiments, the polyamine compound is for example, but not limited to, piperazine, o-phenylenediamine, m-phenylenediamine, p-phenylenediamine, imidazole, pyrimidine, pyrazine, and derivatives thereof.

In some embodiments, the polyfunctional acid halide compound is an aromatic compound with 2-5 acyl chloride groups, preferably 2, preferably 3, preferably 4, and preferably 5 acyl chloride groups. Suitable examples of polyfunctional acid halide compounds phthaloyl chloride, methylphthaloyl chloride, and isophthaloyl chloride (IPC). In a preferred embodiment, the polyfunctional acid halide compound is IPC containing 2 acyl chloride groups.

The active layer further includes NiO NPs. The NiO NPs may exist in various morphological shapes, such as nanospheres, nanowires, nanocrystals, nanosheets, nanorectangles, nanotriangles, nanopentagons, nanohexagons, nanoprisms, nanodisks, nanocubes, nanoribbons, nanoblocks, nanobeads, nanotoroids, nanodiscs, nanobarrels, nanogranules, nanowhiskers, nanoflakes, nanofoils, nanopowders, nanoboxes, nanostars, tetrapods, nanobelts, nano-urchins, nanoflowers, etc., and mixtures thereof. In a preferred embodiment, the NiO NPs are spherical. In some embodiments, the NiO NPs are spherical and have an average diameter of 50-100 nm, preferably 51-99, preferably 52-98, preferably 53-97, preferably 54-96, preferably 55-95, preferably 56-94, preferably 57-93, preferably 58-92, preferably 59-91, preferably 60-90, preferably 61-80, preferably 62-78, preferably 63-76, preferably 64-74, preferably 65-72, preferably 66-71, preferably 67-70, and preferably 68-69 nm.

In some embodiments, a surface of the NiO NPs is functionalized with an amino silane compound. In some embodiments, the NiO particles prior to functionalization have-OH hydroxyl groups on a surface which can be reacted with, thereby functionalizing the surface of the NiO NPs. In a preferred embodiment, at least 50% of the surface of the NiO NPs is functionalized, preferably 60%, 70%, 80%, 90%, or 100%. Suitable examples of amino silane compound include (2-hydroxyethyl)-3-aminopropyl trialkoxy silanes, diethylamino methyl trialkoxy silane, (N, N-diethyl-3-aminopropyl)trialkoxy silane, 3-(N-styryl methyl-2-amino ethylamino propyl trialkoxy silane, (2-N-benzylamino ethyl)-3-aminopropyl trialkoxy silane), trialkoxysilyl propyl group-N, N, N-trimethyl ammonium chloride, N-(trialkoxysilyl ethyl)benzyl-N, N, N-trimethyl ammonium chloride, (two (methyl dialkoxy silyl propyl group)-N-methylamine, two (trialkoxysilyl propyl group) urea, and two (3-(trialkoxysilyl) propyl group)-ethylene diamine. In some embodiments, the amino silane compound includes a carbon chain having 2-20 carbons, preferably 4-18, 6-16, 8-14, or 10-12 carbons with a terminal primary amine (—NH₂). In a preferred embodiment, the amino silane compound is 3-aminopropyl triethoxy silane (APTES).

In some embodiments, the active layer includes 1-90 wt. %, preferably 5-85 wt. %, preferably 10-80 wt. %, preferably 15-75 wt. %, preferably 20-70 wt. %, preferably 25-65 wt. %, preferably 30-60 wt. %, preferably 35-55 wt. %, and preferably 40-50 wt. %, of the NiO NPs, based on the total weight of the active layer.

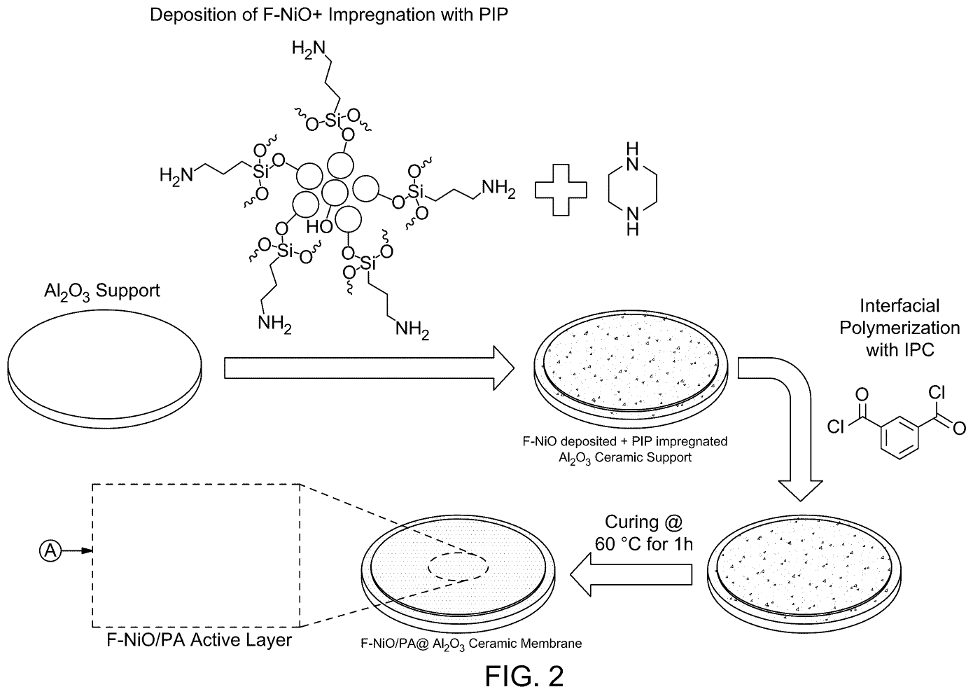

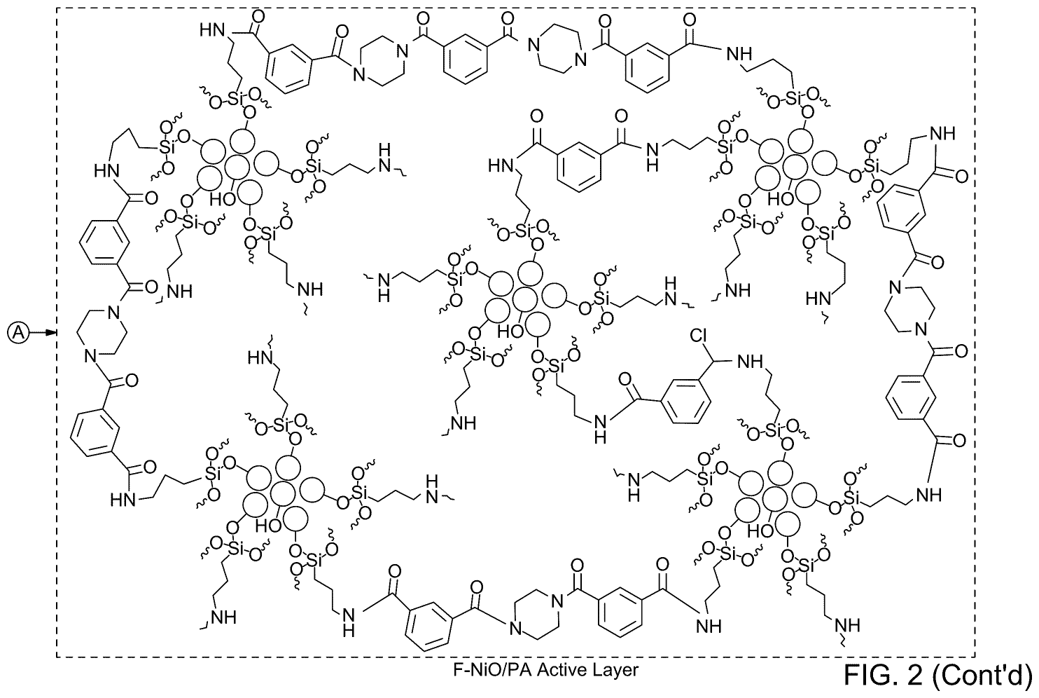

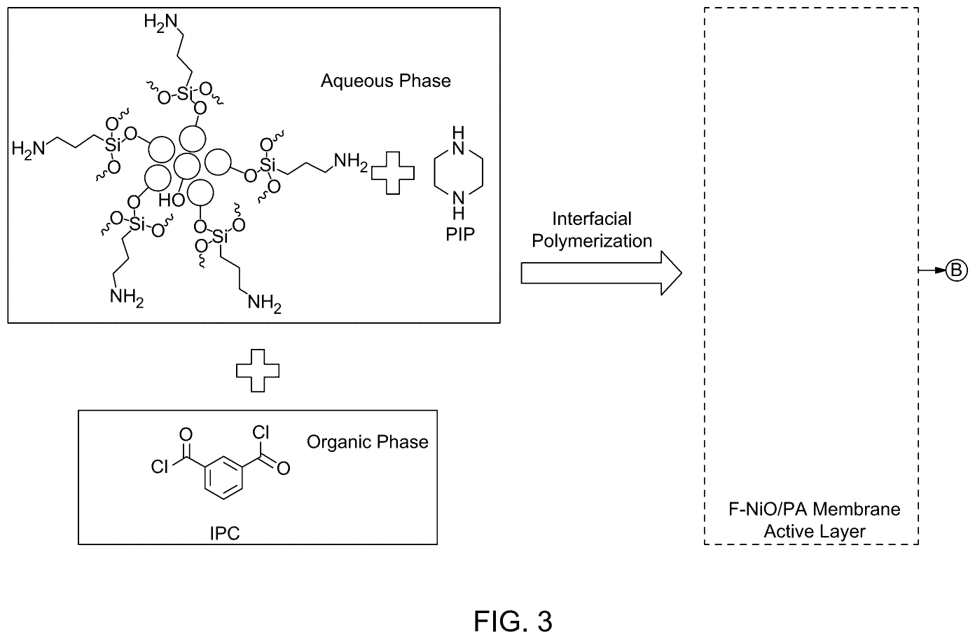

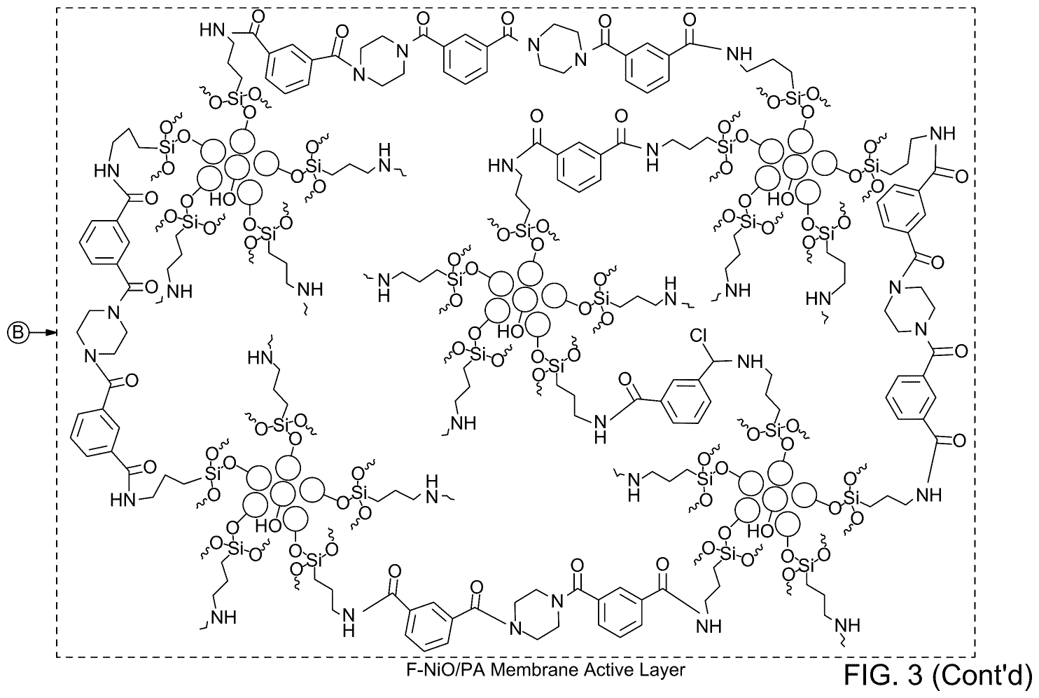

In some embodiments, the polyamine compound, the polyfunctional acid halide compound, and the amino silane compound are interfacially polymerized on the support to form the membrane. In a preferred embodiment, the NiO NPs are covalently bonded in the active layer. In some embodiments, the NiO NPs are uniformly distributed in the active layer. In some embodiments, the first acyl halide group of the polyfunctional acid halide compound is covalently bound to an amine group of the amino silane compound in the interfacial polymerization thereby forming an amide bond. In some embodiments, a second acyl halide group of the polyfunctional acid halide compound is covalently bound to an amine group of the polyamine compound in the interfacial polymerization thereby forming an amide bond. This forms a covalently bonded and interconnected structure of the polyfunctional acid halide compound, the polyamine compound, and the functionalized NiO NPs. An embodiment, of the bonding is shown in FIGS. 2 and 3. One of ordinary skill in the art would recognize that this structure would be modified based on the polyfunctional acid halide compound, the polyamine compound, and functionalized NiO NPs used. In the active layer, the NiO NPs are wrapped by polymeric chains formed during interfacial polymerization.

Following the interfacial polymerization, a continuous active layer is formed on a surface of the support, and covers at least 50%, preferably 60%, 70%, 80%, 90%, or 100%, of the surface of the support. In some embodiments, the active layer is formed only on an outer surface of the support. In a preferred embodiment, the active layer penetrates the pores of the support. In some embodiments, any pores on the support may be considerably covered by the active layer of the membrane. For example, pores of an alumina support with an average size of 0.1-10 μm, may be covered and/or filled with the active layer material, thereby resulting in a different structure and different sized pores. In a preferred embodiment, at least 50% by volume of the pores are filled with the polymerized components of the active layer, preferably 60%, 70%, 80%, 90%, or 100%. Preferably the active layer penetrates into the surface of the support in the pores to a depth of up to 2.5 mm, preferably up to 2 mm, up to 1 mm, up to 0.5 mm, up to 0.2 mm and at least to a depth of 0.10 μm, 50 μm, or 100 μm.

In some embodiments, the membrane has an average pore size of less than 1 μm, preferably 900 nm, 800 nm, 700 nm, 600 nm, 500 nm, 400 nm, 300 nm, 200 nm, 100 nm, 90 nm, 80 nm, 70 nm, 60 nm, 50 nm, 40 nm, 30 nm, 20 nm, 10 nm, 5 nm, or 1 nm.

In some embodiments, the membrane has an oil contact angle in water of greater than 160°, preferably 165°, preferably 170°, preferably 175°, and preferably 180°. In a preferred embodiment, the membrane has an oil contact angle in water of 161°. In an embodiment, the membrane is superoleophilic and superhydrophilic in air. In general, a superhydrophilic surface in the air often exhibits superoleophobicity underwater. This is due to the ability of the superhydrophilic material to trap water, resulting in a robust water layer. Moreover, due to oil immiscibility with the water layer, the material exhibits superoleophobicity when in contact with oil underwater.

In an embodiment, a method of separating an oil and water mixture is described. The method includes passing the oil and water mixture through the prepared membrane to form a filtered solution. In some embodiments, the filtered solution contains at least 80% by weight less of the oil, preferably 85%, preferably 90%, preferably 95%, preferably 96%, preferably 97%, preferably 98%, and preferably 99%. In a preferred embodiment, the membrane demonstrated a high oil and water emulsion separation efficiency of >99%. In a preferred embodiment, the filtered solution contains less than 500 ppm by weight of the oil, preferably less than 400 ppm, 300 ppm, 200 ppm, 100 ppm, 50 ppm, 10 ppm, or 1 ppm.

In some embodiments, the membrane has a permeate flux of 150-250 L m⁻² h⁻¹ (LMH), preferably 155-245, preferably 160-240, preferably 165-235, preferably 170-230, preferably 175-225, preferably 180-220, preferably 185-215, preferably 190-210, and preferably 195-205 L m⁻² h⁻¹ at a pressure of 1 bar.

While not wishing to be bound to a single theory, it is thought that the covalent bonding of the NiO NPs in the membrane active layer during the interfacial polymerization causes the particles to stay in place and form well-defined pores and prevents undesired defects and inhomogeneity. Also, the incorporation of a ceramic alumina (Al₂O₃) support offers increased chemical, thermal, and mechanical stability. The superoleophobicity underwater of the membrane can be attributed to the hydrophilic nature of the components in the active layer resulting in a strong hydration layer on the membrane surface, which offers repulsion to the oil coming to the membrane. Therefore, the oil is efficiently rejected by the membrane with reduced evidence of membrane fouling.

### EXAMPLES

The following examples demonstrate the membrane as described herein. The examples are provided solely for illustration and are not to be construed as limitations of the present disclosure, as many variations thereof are possible without departing from the spirit and scope of the present disclosure.

### Example 1: Chemicals and Reagents

Nickel (II) oxide nanoparticles (NPs) (99%; NiO, Particle size=˜ 50-80 nm), 3-aminopropyl triethoxy silane [99%; APTES; H₂N(CH₂)₃Si(OC₂H₅)₃], piperazine (99%; PIP; C₄H₁₀N₂), isophthaloyl chloride [>99%; IPC, C₆H₄,1-3(COCl)₂], triethylamine [>99%; TEA, (C₂H₅)₃N] and sodium dodecyl sulfate (99%; SDS; NaCl₂H₂₅SO₄) were purchased from Sigma (USA). Organic solvents, including n-hexane, ethanol, and methanol, were acquired from Fisher Scientific. The supports made of alumina ceramic were purchased from HIGHBORN New Materials Co., LTD. in China.

### Example 2: Functionalization of NiO NPs (F—NiO)

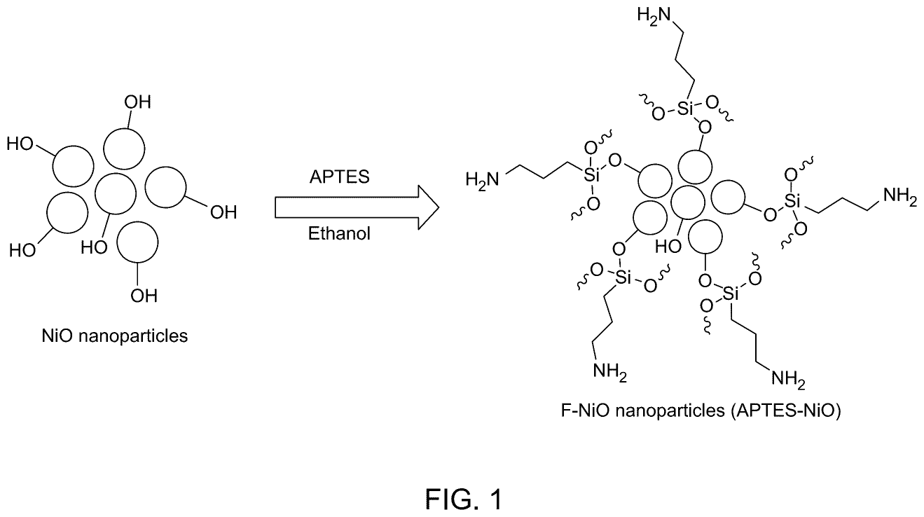

Referring to FIG. 1, a schematic representation depicting a scheme for preparing amino-functionalized NiO NPs (F—NiO) using APTES as a functionalizing agent is illustrated. As can be seen from FIG. 1, the NiO NPs were amino-functionalized using APTES as a functionalizing agent. Initially, 1 gram of NiO NPs was homogeneously dispersed in 99 ml of ethanol and 1 ml of water using a bath ultra-sonicator in a round bottom flask for 15 minutes. Then, 5 ml of APTES was added to the above dispersion and stirred for 48 hours at 50° C. After 48 hours, the amino-functionalized NiO NPs (F—NiO) were centrifuged and thoroughly washed using ethanol and water. Finally, F—NiO was dried in an air oven before being employed to fabricate the membrane.

### Example 3: Fabrication of F—NiO/PA@Alumina Membrane

FIG. 2 illustrates a schematic diagram depicting the steps involved in fabricating the F—NiO/PA@Alumina membrane. The F—NiO/PA@Alumina membrane was fabricated by depositing F—NiO NPs on the surface of commercial alumina support with the help of a dead-end-filtration cell, followed by interfacial polymerization employing PIP as an external amine and IPC as a crosslinker. The F—NiO NPs dispersed aqueous solution containing 2% PIP and 4% TEA was prepared using an ultra-sonicator. The F—NiO NPs dispersed aqueous solution was passed through the dead-end-filtration cell (Sterlitech) equipped with commercial alumina support at a constant nitrogen gas pressure of 2 bar. Furthermore, the above-described process deposits the F—NiO NPs and impregnates the alumina support with an external amine (PIP). In addition, the F—NiO NPs deposited, and PIP-impregnated alumina support was removed from the cell and dried completely in air. The dried F—NiO NPs were deposited, and the impregnated alumina membrane was subjected to interfacial polymerization (IP) employing an organic solution of 0.15% IPC crosslinker in n-hexane for 20 minutes. Further, the membrane was removed from the IPC solution after 20 minutes of IP reaction and rinsed with fresh n-hexane to eliminate any leftover unreacted monomers. In the final step, the membrane was cured at 80° C. in a heating oven for 1 h to achieve the F—NiO/PA@Alumina membrane, where PA refers to polyamide.

### Example 4: Characterization Techniques

The NiO and F—NiO NPs, alumina membrane support, and F—NiO/PA@Alumina membrane was characterized by using X-ray diffraction (XRD, MiniFlex-600, Rigaku, Japan), Scanning electron microscopy coupled with Energy dispersive X-ray spectroscopy (SEM/EDX, Coxem EM-30AX SEM, Korea) and Attenuated Total Reflectance Fourier transform Infrared spectrometer (ATR-FTIR, Nicolet iS-50, Thermo Fisher Scientific, United States of America). The F—NiO/PA@Alumina membrane was also characterized using a goniometer (KRUSS, DSA25, Germany) to measure the water and oil contact angles.

### Example 5: Crude Oil from Oil-In-Water (O/W) Separation Method

A crossflow filtering setup was used to assess the F—NiO/PA/PA@Alumina ceramic membrane's capacity to separate crude oil-in-water emulsion. To prepare the stock feed solution of 1000 parts per million (ppm) crude oil-in-water emulsion, crude oil (1 g) and water (1 L) were mixed with 500 mg SDS as an emulsifying agent using a shear mixer operating at 30000 rounds per minute (rpm). To determine the impact of various feed concentrations on the membrane permeate flux and separation efficiencies, various feed solutions of 50 ppm, 100 ppm, and 200 ppm crude oil-in-water emulsions were generated using the 1000 ppm crude oil-in-water emulsion stock feed solution. The effect of pressure on pure water flux, the effect of pressure on permeate flux and oil-in-water emulsion separation efficiency using crude oil-in-water emulsion, as well as the stability of the membrane in terms of permeate flux and oil-in-water emulsion separation efficiency over time, were assessed and computed. The optical microscopic images of the feed and permeate samples were also taken using a Zeiss optical microscope.

### Example 6: Characterization

FIG. 3 illustrates a schematic diagram depicting the interfacial polymerization reaction between functionalized NiO (F—NiO) and IPC yielding the proposed polyamide active layer with NiO particles decorated in the active layer framework. To enhance the possibility of covalently attaching the NiO NPs in the framework of the polyamide active layer of the membrane, NiO was decorated by several amino groups (—NH₂) using APTES condensed on hydroxyl groups (—OH) groups of NiO. The amino groups react with the acid chloride (—COCl) groups on the crosslinker IPC. Hence, the resulting polyamide active layer includes all the reacting components, as shown in the proposed structure of the active layer.

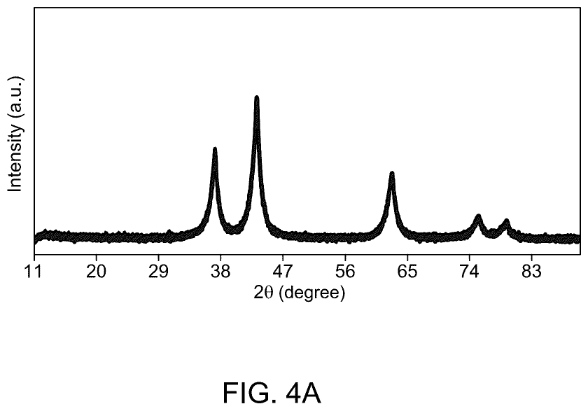

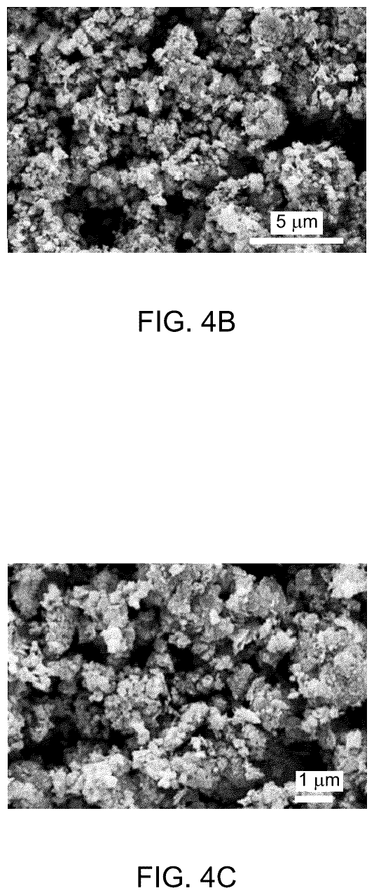

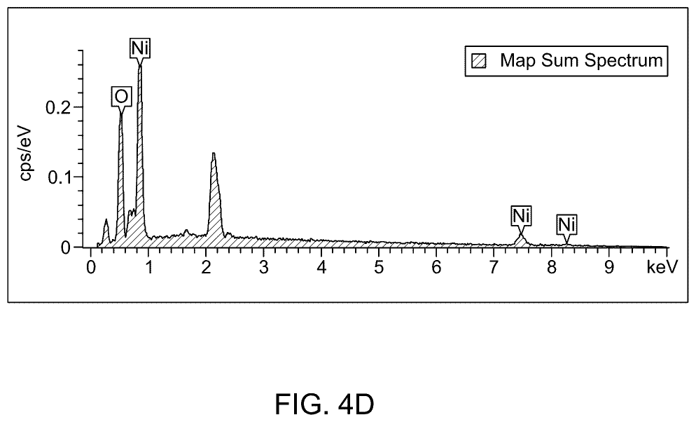

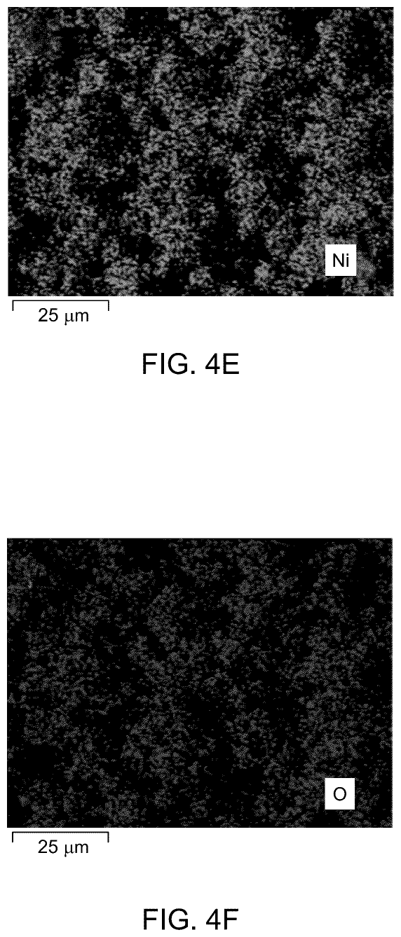

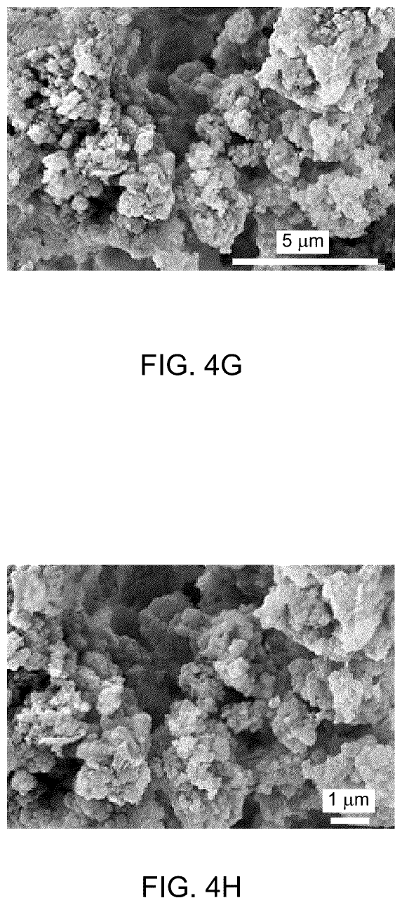

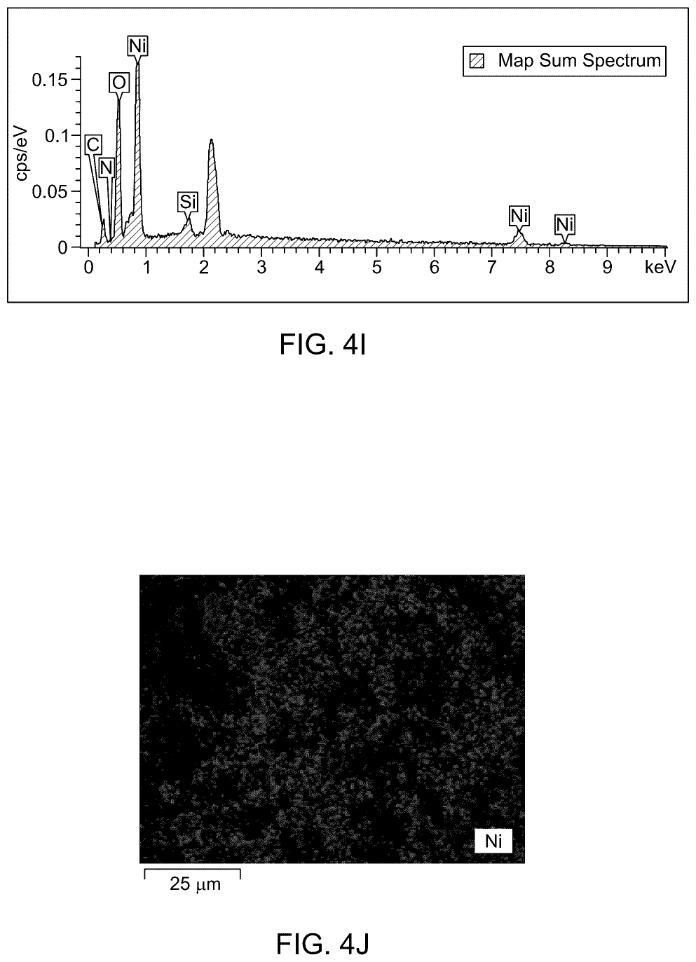

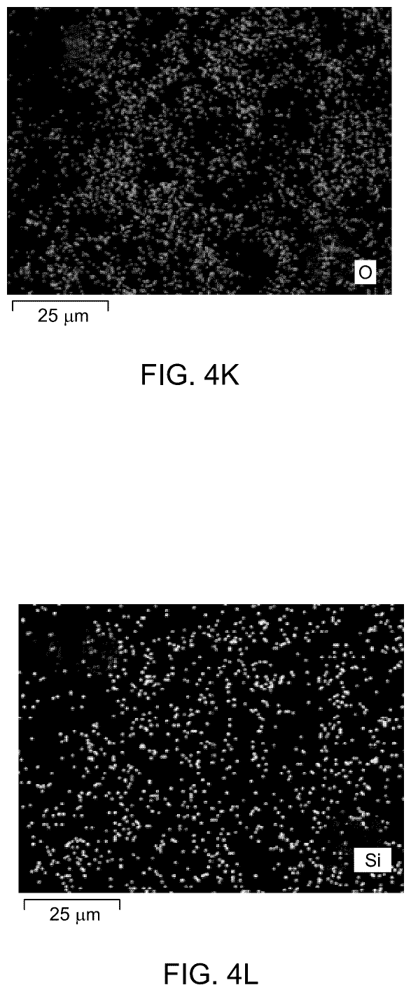

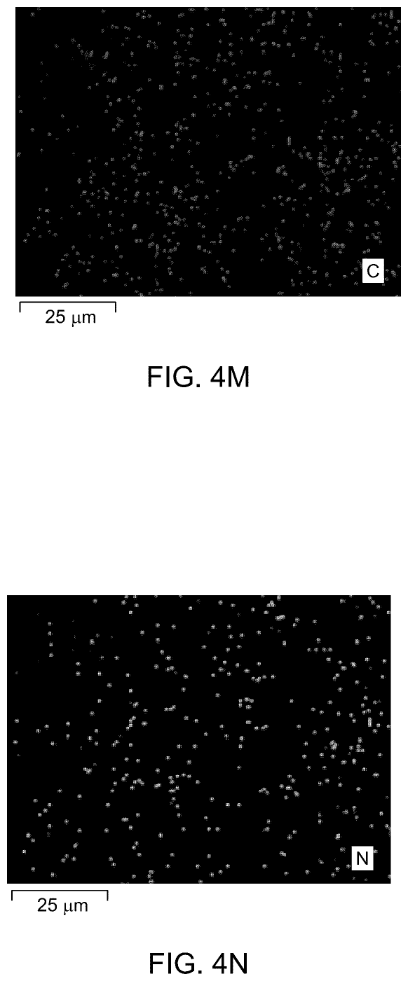

FIG. 4A depicts powder X-ray diffraction (PXRD) patterns of NiO NPs. The PXRD pattern of NiO particles showed peaks responsible for the planes and phases of NiO crystallographic structure. The diffraction peaks that are located at 2θ=37.2°, 43.2°, 62.8°, 75.2°, and 79.38° are due to the (111), (200), (220), (311), and 222 crystal planes of NiO particles. Positions and the peak intensities found for the NiO particles perfectly agree with the standard spectrum (JCPDS No. 04-0835). The presence of these peaks shows that the NiO particles were highly pure and lack the presence of any other impurity in the structure of NiO particles

FIGS. 4B-4C are pictorial representations depicting scanning electron microscopy (SEM) images of NiO particles. SEM analysis of the NiO particles revealed the presence of agglomerated NiO particles grown in the form of rough-surfaced coagulates. Referring to FIG. 4D, depicts the energy dispersive X-ray (EDX) analysis results for NiO particles. Elemental composition analysis through EDX revealed the presence of nickel (Ni) and oxygen (O) in the structure of the NiO. FIGS. 4E-4F are pictorial representations depicting the elemental mapping analysis for NiO. As can be seen from FIGS. 4E-4F, elemental mapping analysis demonstrated that both Ni and O are uniformly distributed throughout the structure of NiO. FIGS. 4G-4H show pictorial representations depicting SEM micrographs for F—NiO particles. The SEM micrographs of F—NiO particles showed a remarkable alteration compared to NiO particles. The F—NiO particles showed a relatively smoother surface with the filled structure due to the covering of NiO with APTES, resulting in functionalization of NiO leading to F—NiO. The change in the surface morphology of F—NiO upon treatment with APTES confirmed the successful functionalization of NiO particles. FIG. 4I shows EDX analysis results for the F—NiO particles is illustrated. As can be seen from FIG. 4I, additional elements such as carbon (C), nitrogen (N), and silicon (Si) were found in the EDX analysis. FIGS. 4J-4N show pictorial representations depicting the elemental mapping analysis for various elements present in the F—NiO particles are illustrated. The elements were uniformly distributed throughout the entire region of scanned F—NiO particles. As can be seen from FIGS. 4J-4N, the relevant concentrations of all the elements in the structure of F—NiO were reflected in the concentration of the elemental dots as shown. Hence, different characterization techniques not only confirmed the structure of NiO but also the functionalization of F—NiO.

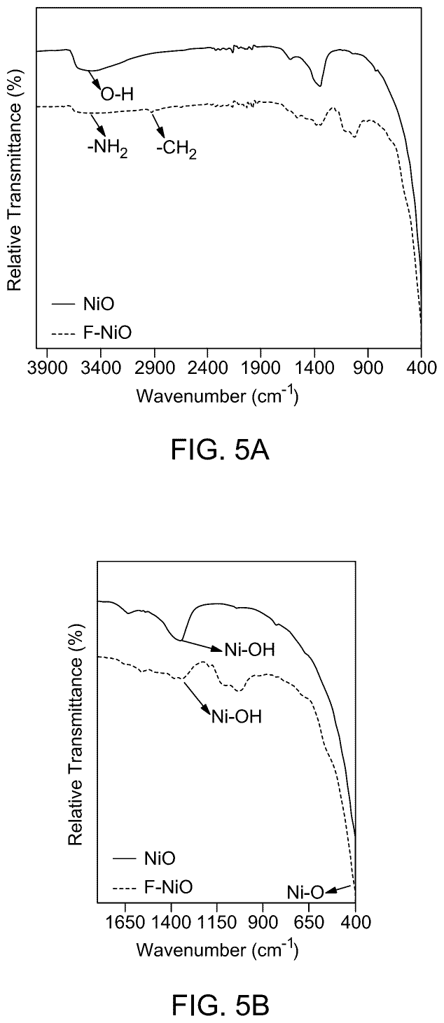

FIGS. 5A-5B show Fourier transform infrared (FTIR) spectra of NiO and F—NiO, and their respective fingerprint regions. The confirmation of the functionalization of NiO particles was carried out through FTIR of NiO and F—NiO. A strong absorption band at around 400 cm⁻¹ was observed due to the existence of a Ni—O vibrational mode. Similarly, other absorption bands present at 3500 cm⁻¹ and 1400 cm⁻¹ are due to the O—H and Ni—OH vibrations of the NiO. However, upon functionalization, certain variations in the FTIR spectrum of F—NiO were observed, such as a small absorption band at around 2900 cm⁻¹ due to aliphatic —CH₂— groups of APTES. In addition, the peaks appeared at around 1100 cm⁻¹ due to the C—N stretching vibration of APTES. The peak for F—NiO at 3500 cm⁻¹ also showed a variation as it became less deep and broader than NiO's. These observations concluded that NiO was appropriately functionalized using APTES, which introduced amino groups on the NiO surface, making NiO decoration feasible and stable when deposited on the membrane surface during IP.

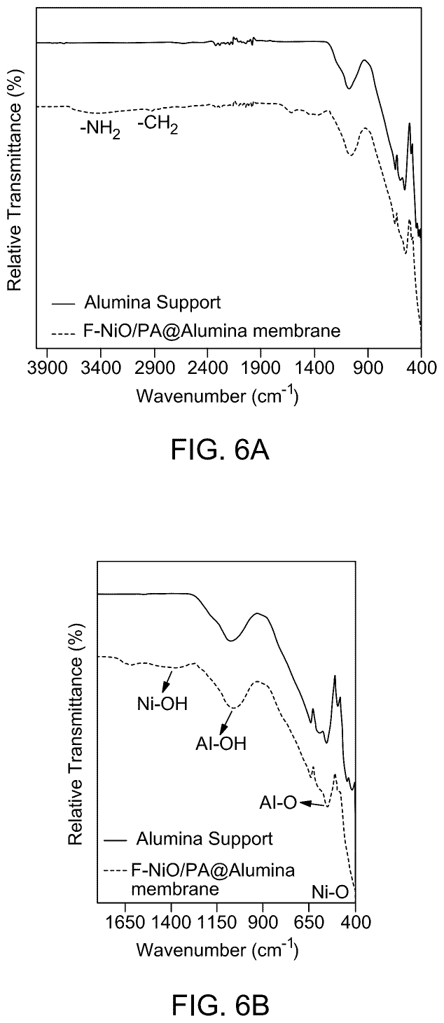

FIGS. 6A-6B show FTIR spectra of the alumina support and F—NiO/PA@Alumina membrane. Upon decoration of NiO containing active layer on alumina ceramic support, the active layer deposition was confirmed through different characterization techniques. A variation in the characteristic spectrum of alumina support was observed when the NiO-containing polyamide active layer was deposited on the ceramic support. The peaks at 3500 cm⁻¹, 3000 cm⁻¹, 2900 cm⁻¹, 1650 cm⁻¹, 1400 cm⁻¹, and 400 cm⁻¹ are due to the F—NiO decoration in the polyamide active layer of the membrane (F—NiO/PA active layer). The peaks of the active layer are considerably masked due to the higher amount of alumina compared to the thin active layer of the membrane.

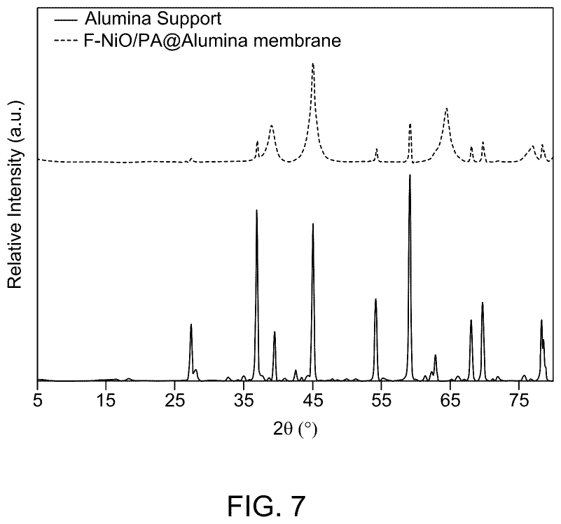

FIG. 7 depicts XRD patterns of the alumina support and F—NiO/PA@Alumina membrane. As can be seen from FIG. 7, the XRD pattern of the bare and fabricated ceramic-polymeric hybrid membrane was recorded. The XRD pattern of the fabricated membrane showed considerable variation compared to the bare alumina support. However, after IP and deposition of the NiO-containing polyamide active layer on the alumina support, it resulted in variation in both the intensity and peak area of the diffraction peaks of the F—NiO/PA@Alumina membrane. The peaks in the F—NiO/PA@Alumina membrane is a mix of peaks due to alumina and NiO, whereas the changes in the peak area and intensity are indicative of the inclusion of polymeric polyamide in the active layer of the F—NiO/PA@Alumina membrane. The masking of peaks of alumina, such as a peak at 28° in the case of F—NiO/PA@Alumina membrane, demonstrated that the F—NiO/PA active layer considerably covers planes and particles of alumina. The decrease in the intensities of all the peaks for the F—NiO/PA@Alumina membrane confirmed the successful deposition of F—NiO/PA on the alumina support, resulting in a stable F—NiO/PA@Alumina membrane.

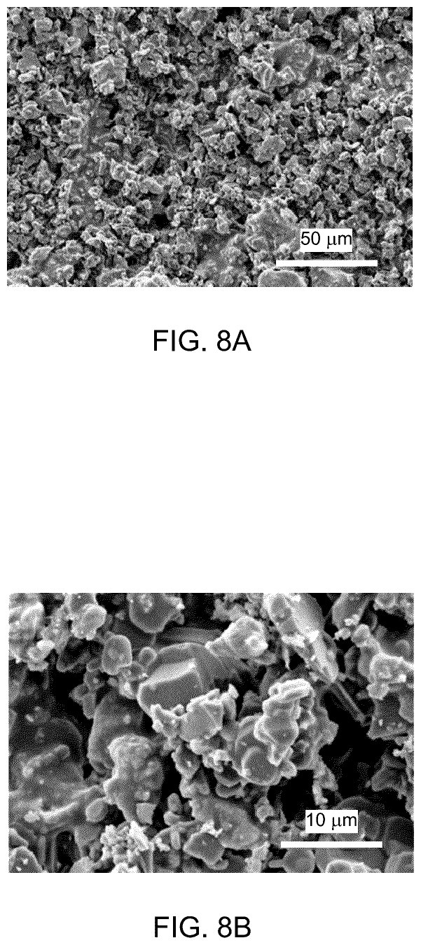

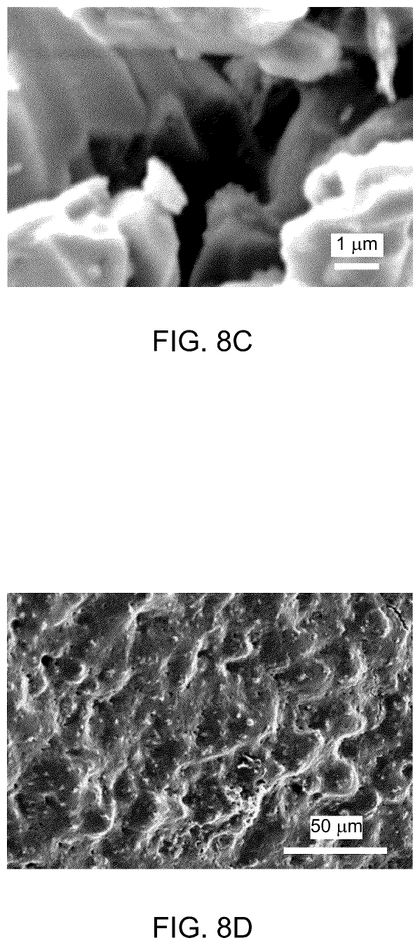

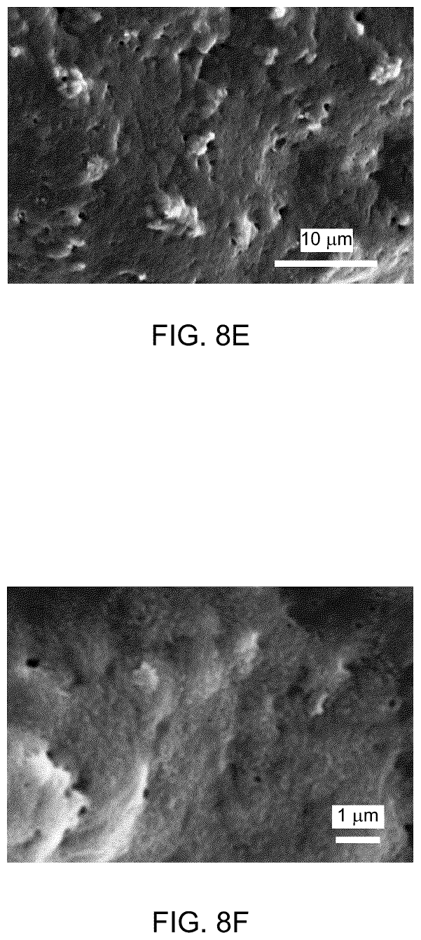

FIGS. 8A-8C depicts SEM micrographs of bare alumina support at different magnifications. The SEM micrographs of bare alumina support revealed a microporous structure having irregularly shaped crystalline alumina particles (FIGS. 8A-8C). However, the growth of the F—NiO/PA active layer on the alumina support demonstrated a uniformly grown polyamide active layer in the case of the F—NiO/PA@Alumina membrane. FIGS. 8D-8F depict SEM micrographs of the F—NiO/PA@Alumina membrane at different magnifications. The SEM micrographs of the F—NiO/PA@Alumina membrane showed the existence of a continuous active layer when the micropores of the bare alumina support were considerably covered by the active layer of the membrane. A comparatively smoother membrane surface in the case of the F—NiO/PA@Alumina membrane is attributed to the polymeric-ceramic nature of the active layer, where the polyamide polymeric chains completely wrap the NiO particles.

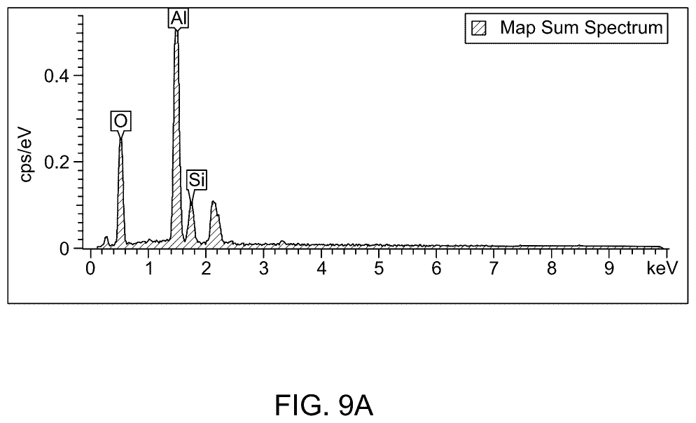

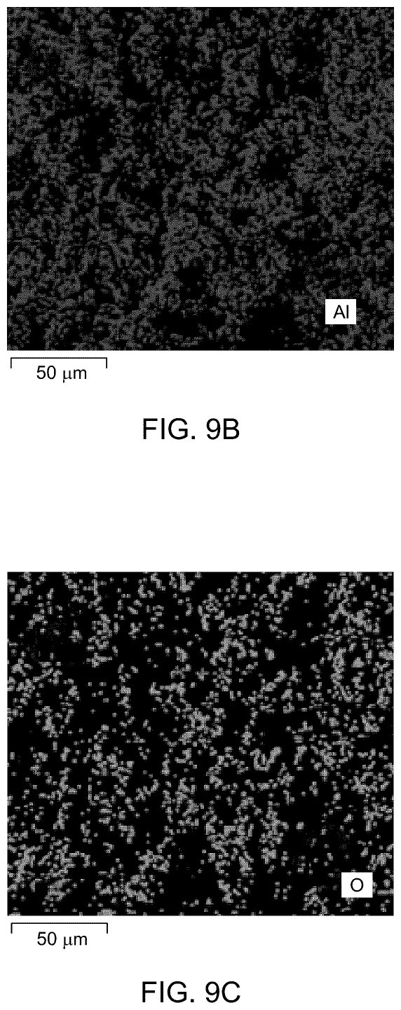

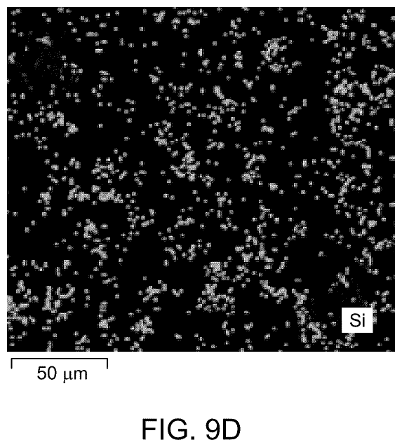

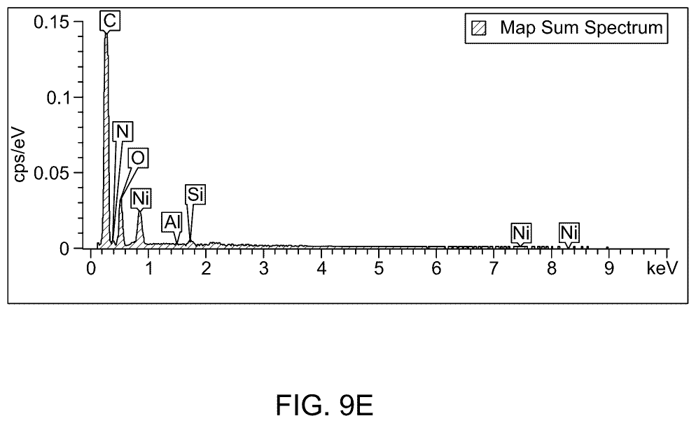

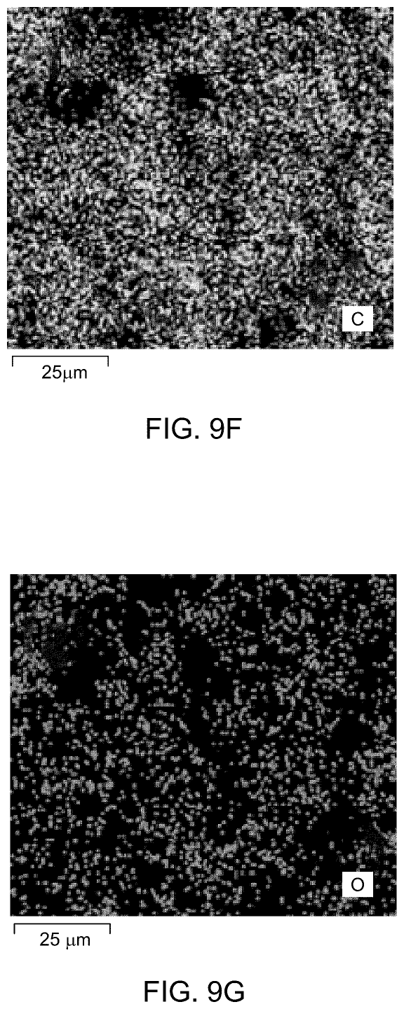

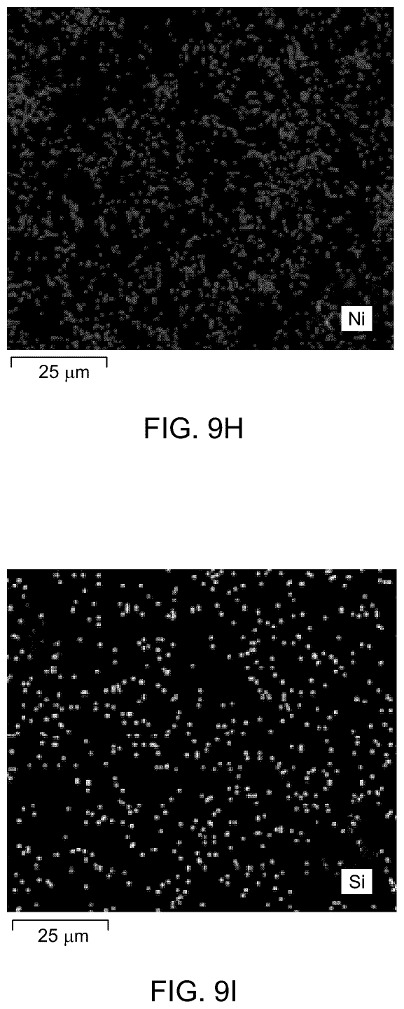

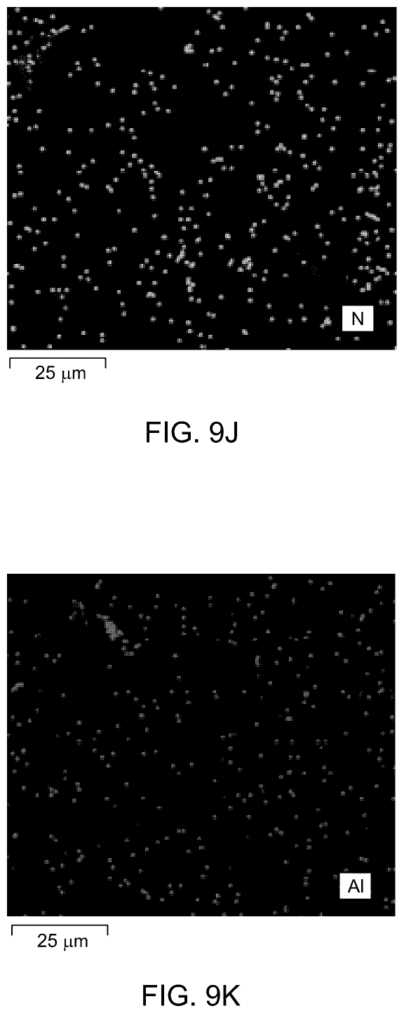

FIG. 9A depicts the EDX analysis results for the alumina support. As can be seen from FIG. 9A, EDX analysis confirmed the elemental composition of the membranes as alumina (Al₂O₃) support is composed of aluminum (Al) and oxygen (O), and the presence of these elements was noted in EDX analysis of the alumina support. FIGS. 9B-9D depict elemental mapping analysis for the alumina support. As can be seen from FIGS. 9B-9D, the elemental mapping analysis of the alumina support confirmed the presence of Al, O, and Si, respectively, in the alumina support and a uniform distribution of the aforementioned elements throughout the structure of the alumina support. FIG. 9E shows EDX analysis results for the F—NiO/PA@Alumina membrane. The EDX analysis of the F—NiO/PA@Alumina membrane confirmed the existence of C, N, and Ni in addition to Al and O of the alumina support. FIGS. 9F-9K show elemental mapping analysis of the F—NiO/PA@Alumina membrane. As can be seen from FIGS. 9F-9K, the elemental mapping analysis of the F—NiO/PA@Alumina membrane confirmed the presence of C, O, Ni, Si, N, and Al, respectively, in the F—NiO/PA@Alumina membrane, as well as a uniform distribution of the aforementioned elements throughout the structure of the F—NiO/PA@Alumina membrane. This confirmatory evidence indicates the successful growth of NiO-containing polyamide active layer on the alumina support.

Surface wettability is a surface feature of a membrane, and super-hydrophilic and underwater super oleophobic membranes are highly desirable for separating O/W emulsions. A super-hydrophilic membrane with an underwater super-oleophobic nature has the potential to avoid excessive surface fouling due to oil wetting the membrane surface. As such, under the filtration conditions, the underwater super-oleophobic nature of the membrane does not allow the oil to come in contact with the membrane surface, and hence, the fouling of the membrane is reduced.

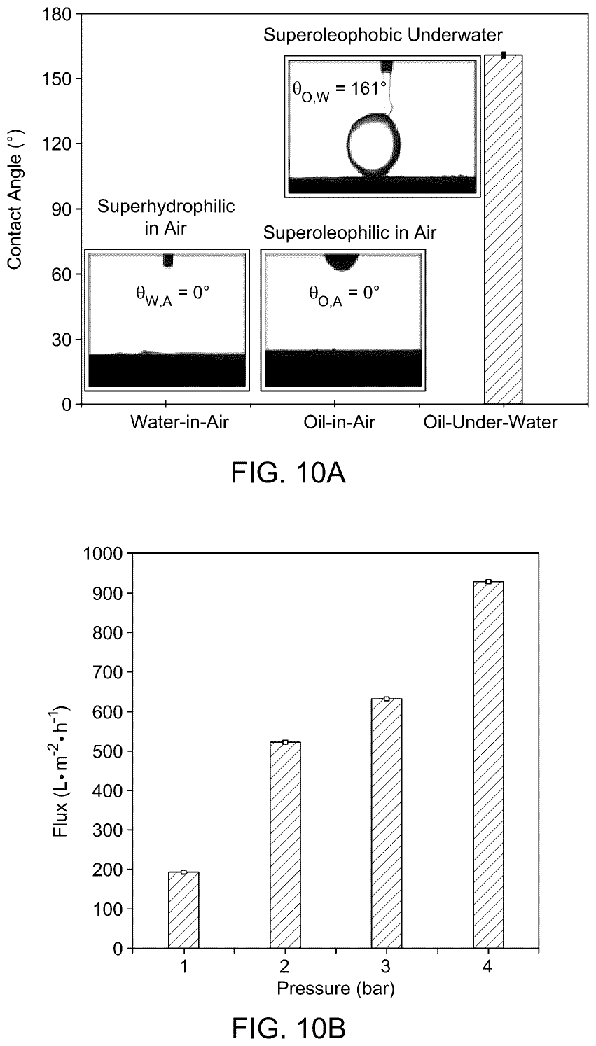

FIG. 10A depicts the surface wettability analysis of the F—NiO/PA@Alumina membrane. The above-described feature of the F—NiO/PA@Alumina membrane was confirmed through contact angle measurement using both oil and water to wet the membrane surface in air and aqueous media. When the water (WCA; θ_{W, A}) and oil contact angles (OCA; θ_{O, A}) of the F—NiO/PA@Alumina membrane were measured in air, the membrane demonstrated both superhydrophilic and superoleophobic wettability. However, upon measuring the oil contact angle in water (θ_{O, W}), the F—NiO/PA@Alumina membrane showed superoleophobic properties as the θ_{O, W} was found to be 161°. The special wettability feature of the F—NiO/PA@Alumina membrane can be attributed to the hydrophilic nature of all the components of the membrane that include NiO, alumina (Al₂O₃), and polyamide (PA). Since all the components of the F—NiO/PA@Alumina membrane is hydrophilic, these components led to the establishment of a strong hydration layer on the membrane surface, which offers repulsion to the oil coming to the membrane. Therefore, the oil is efficiently rejected by the F—NiO/PA@Alumina membrane with reduced evidence of membrane fouling.

### Example 6: Membrane Performance

FIG. 10B illustrates the variation of permeate flux of the F—NiO/PA@Alumina membrane as a result of increasing transmembrane pressure. Owing to the superhydrophilic nature, the F—NiO/PA@Alumina membrane showed a considerably higher pure water permeate flux which varied linearly with increasing transmembrane pressure. As the transmembrane pressure was raised from 1 bar to 4 bar, the permeate flux increased from 190 L m⁻² h⁻¹ (LMH) to 930 LMH. This consistent rise in permeate flux is indicative of the stable structure of the membrane under the filtration conditions.

The separation potential of the F—NiO/PA@Alumina membrane was analyzed by applying an emulsified oily feed onto the membrane. The permeate flux with oily emulsion showed a decrease in permeate flux compared to the flux of deionized (DI) water feed. This observation indicates that despite the superhydrophilic and underwater superoleophobic wettability, the F—NiO/PA@Alumina membrane was fouled by the oil during filtration experiments. Hence, membrane fouling is inevitable even in the best scenario of membrane surface wettability.

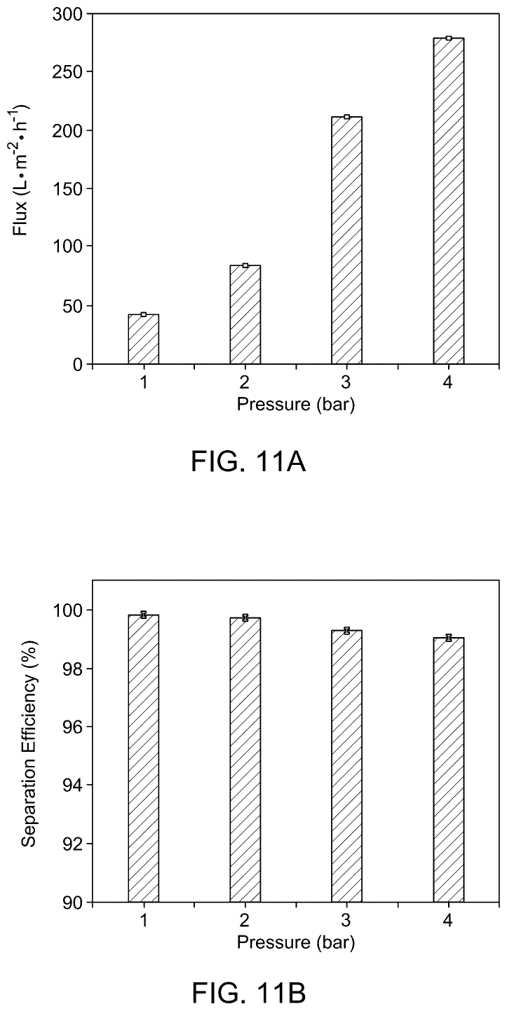

FIG. 11A depicts the variation in permeate flux as a function of increasing transmembrane pressure of the F—NiO/PA@Alumina membrane. As can be seen from FIG. 11A, the permeate flux showed an increase with increasing transmembrane pressure, with permeate flux reaching 280 LMH at 4 bar. FIG. 11B illustrates the separation efficiency of the F—NiO/PA@Alumina membrane due to increasing transmembrane pressure using 100 ppm crude oil-in-water emulsion. As can be seen from FIG. 11B, the separation efficiency of the F—NiO/PA@Alumina membrane stayed consistently higher, reaching more than 99% at all the tested pressures. Hence, it can be said with confidence that the NiO/PA active layer was dense enough to completely separate the oil from the O/W emulsion, which was confirmed through SEM analysis. However, a slight decrease in separation efficiency with increasing transmembrane pressure was also measured, possibly due to a decrease in mass transfer resistance at higher pressures due to the ultrafiltration nature of the membrane. Regardless, the separation efficiency of the F—NiO/PA@Alumina membrane remained at more than 99%.

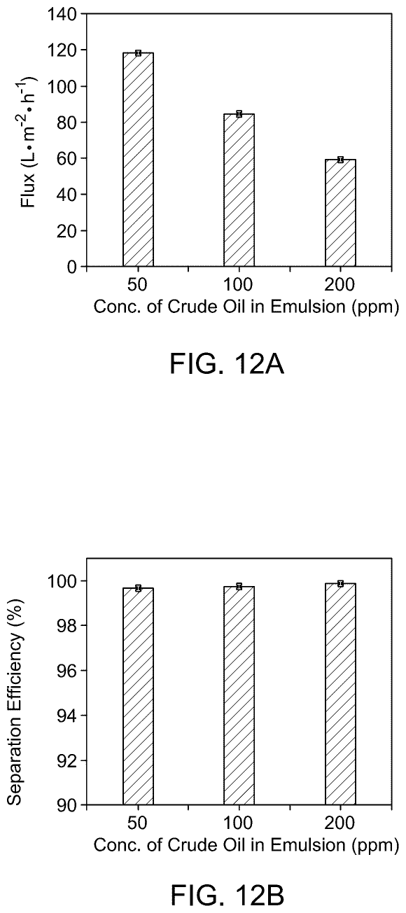

FIG. 12A illustrates the variation in permeate flux of the F—NiO/PA@Alumina membrane as a function of increasing oil concentration in the O/W emulsion. As can be seen from FIG. 12A, the crude oil concentration in the feed varied from 50 ppm to 200 ppm. A noticeable decline in permeate flux was measured when crude oil was increased from 50 ppm to 200 ppm. The increase in oil concentration led to oil deposition on the membrane surface, causing a decrease in permeate flux.

FIG. 12B depicts the separation efficiency of the F—NiO/PA@Alumina membrane due to increasing oil concentration in the O/W emulsion using a plurality of concentrations of crude oil is illustrated. As can be seen from FIG. 12B, the crude oil concentration varies from 50 ppm to 200 ppm at a steady increment of 50 ppm. The separation efficiency of the F—NiO/PA@Alumina membrane increased with increasing oil concentration. This is because the oil deposition on the pores and surface of the membrane resulted in the narrowing of the pores, which eventually increased the separation efficiency of the F—NiO/PA@Alumina membrane.

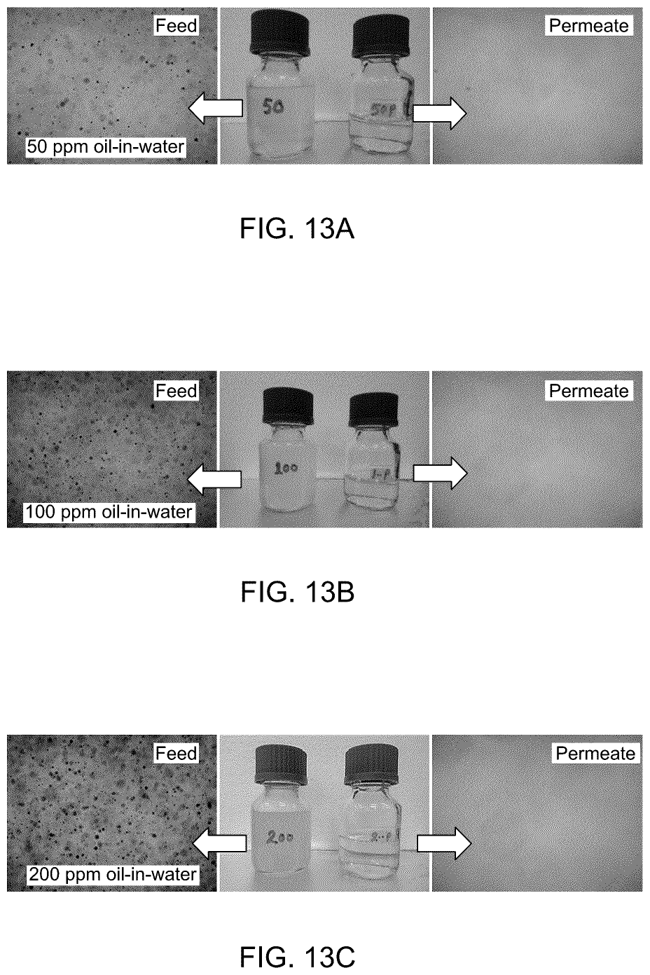

FIGS. 13A-13C show pictorial representations of oil in water feed at various concentrations (50,100, and 200 ppm, respectively) and permeate. The permeate is generated by filtering the oil in water feed via the F—NiO/PA@Alumina membrane. The permeate appears free from contamination, confirming the excellent separation performance of the F—NiO/PA@Alumina membrane.

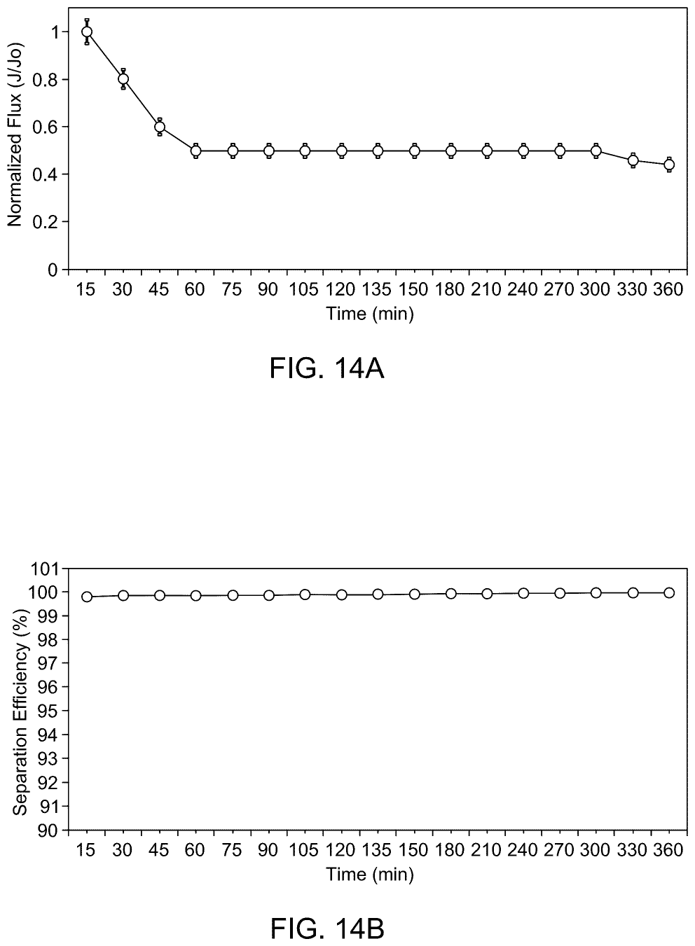

FIG. 14A shows the stability testing of the F—NiO/PA@Alumina membrane in terms of variation in the permeate flux. As can be seen from FIG. 14A, the permeate flux declined during the initial membrane testing. The flux decreased by 50% during the initial O/W separation experiments as the cake formation happens rapidly on the membrane surface as the attachment sites are abundantly available. However, with time, the membrane surface is progressively covered by the foulants, and further reduction in flux was not observed. FIG. 14B depicts the separation efficiency of the F—NiO/PA@Alumina membrane using 100 ppm crude oil in O/W emulsion. It is evident from FIG. 14B, the permeate flux remained stable after the first hour of the stability test, whereas the separation performance of the membrane remained almost stable at more than 99%.

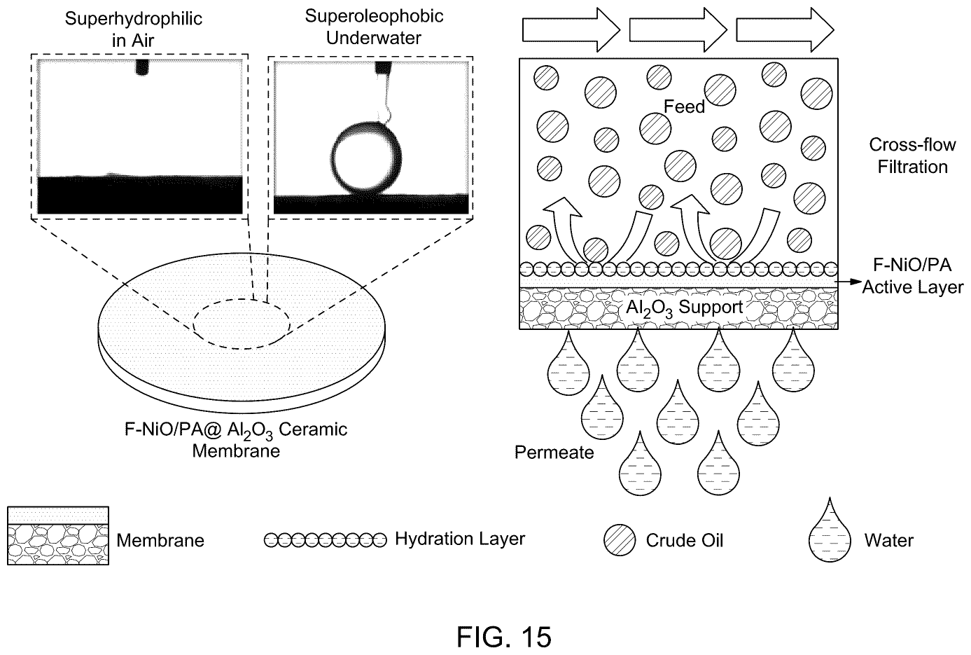

FIG. 15 is a schematic diagram depicting a scheme for surfactant stabilized crude oil-in-water emulsion separation using a cross-flow filtration system. The separation mechanism for separating oil from water using a surfactant stabilized O/W emulsion as a feed through a F—NiO/PA@Alumina membrane in cross-flow mode is provided. The F—NiO/PA@Alumina membrane has a special wettability of being super-hydrophilic and super-oleophobic underwater. As a result of the superhydrophilicity, a strong hydration layer is built on the membrane surface, which repels the oil, and hence the oil is not able to wet the membrane surface while the water is allowed to pass through the membrane, which leads to the separation of oil from water. Therefore, the current approach is advantageous in lowering the evidence of membrane fouling in a cross-flow mode, which is generally an industrially adopted mode for membrane-based separations.

Numerous modifications and variations of the present disclosure are possible in light of the above teachings. It is therefore to be understood that within the scope of the appended claims, the invention may be practiced otherwise than as specifically described herein.

What is claimed is:

1: A membrane, comprising:
a support; and
an active layer,
wherein the active layer comprises reacted units of:
a polyamine compound;
a polyfunctional acid halide compound; and
nickel oxide (NiO) nanoparticles (NPs),
wherein a surface of the NiO NPs is functionalized with an amino silane compound, and
wherein the polyamine compound, the polyfunctional acid halide compound, and the amino silane compound are interfacially polymerized on the support to form the membrane.

2: The membrane of claim 1, wherein the polyamine compound is a cyclic polyamine having 4 to 8 atoms in a ring.

3: The membrane of claim 1, wherein the polyamine compound has 2 to 5 amine groups.

4: The membrane of claim 1, wherein the polyfunctional acid halide compound is an aromatic compound with 2 to 5 acyl chloride groups.

5: The membrane of claim 1, wherein the amino silane compound comprises a carbon chain with a terminal primary amine.

6: The membrane of claim 1, wherein in the active layer the NiO NPs are wrapped by polymeric chains formed during interfacial polymerization.

7: The membrane of claim 1, wherein the NiO NPs are uniformly distributed in the active layer.

8: The membrane of claim 1, wherein the NiO NPs are covalently bonded in the active layer.

9: The membrane of claim 8, wherein a first acyl halide group of the polyfunctional acid halide compound is covalently bound to an amine group of the amino silane compound thereby forming an amide bond.

10: The membrane of claim 9, wherein a second acyl halide group of the polyfunctional acid halide compound is covalently bound to an amine group of the polyamine compound thereby forming an amide bond.

11: The membrane of claim 1, wherein the support is a ceramic support.

12: The membrane of claim 1, wherein the support is an alumina support.

13: The membrane of claim 1, wherein the membrane has an average pore size of less than 1 micrometer (μm).

14: The membrane of claim 1, wherein the membrane has an average pore size of 1 nanometer (nm) to 100 nm.

15: The membrane of claim 1, wherein the active layer comprises 1 weight percent (wt. %) to 90 wt. % of the NiO NPs, based on total weight of the active layer.

16: The membrane of claim 1, wherein the NiO NPs are spherical and have an average diameter of 50 nm to 100 nm.

17: The membrane of claim 1, wherein the membrane has an oil contact angle in water of greater than 160°.

18: A method of separating an oil and water mixture, comprising:
passing the oil and water mixture through the membrane of claim 1 to form a filtered solution,
wherein the filtered solution comprises at least 80% less of the oil than the oil and water mixture.

19: The method of claim 18, wherein the membrane has a permeate flux of 150 L m⁻² h⁻¹ (LMH) to 250 LMH at 1 bar.
